(19) United States
(12) Patent Application Publication
(10) Pub. No.: US 2024/0428276 A1
(43) Pub. Date: Dec. 26, 2024

(54) PROCESSING APPARATUS, CONTROL METHOD OF PROCESSING APPARATUS, AND PROGRAM RECORDING MEDIUM

(71) Applicant: CANON KABUSHIKI KAISHA, Tokyo (JP)

(72) Inventor: HIROSHI TOJO, Tokyo (JP)

(21) Appl. No.: 18/742,284

(22) Filed: Jun. 13, 2024

(30) Foreign Application Priority Data
Jun. 21, 2023 (JP) 2023-101648

(51) Int. Cl. G06Q 30/0201; G06T 7/70; G06V 40/20

(52) U.S. Cl. CPC G06Q 30/0201; G06T 7/70; G06V 40/20

(57) ABSTRACT

A processing apparatus according to one aspect of the present invention acquires a video of a place where a target object is located; acquires characteristic information related to an angle and a distance at which the target object can be gazed at; sets a gaze region, which is a region where the target object can be gazed at, based on the characteristic information that has been acquired; and determines whether or not the person has gazed at the target object, based on information on a joint point of a person who is present in the gaze region that has been set.

### BACKGROUND OF THE INVENTION

### Field of the Invention

The present invention relates to a processing apparatus, a control method of the processing apparatus, and a program recording medium.

### Description of the Related Art

In recent years, a technology for detecting a behavior of a person from a video captured by a monitoring camera has been proposed, and the technology has been applied to analysis of a behavior of a customer in a store is in progress. In a case in which a store sells a new product and the like, there is a demand for measuring the degree of interest of a customer in the new product and the like. The degree of interest of a customer appears in behaviors such as stopping in front of the product and gazing at the product and picking up the product by hand. As for whether or not a customer has gazed at the product, a method of utilizing a monitoring camera installed in a store has been proposed.

In the method disclosed in Japanese Patent Application Laid-Open No. 2017-117384, the line-of-sight direction of a person is detected from a video, and a product viewed by the person is determined. Additionally, in Japanese Patent Application Laid-Open No. 2009-104524, details of a method for detecting a line-of-sight direction are described, and the line-of-sight direction is determined from the direction of the face and the center position of the pupil.

Although, in Japanese Patent Application Laid-Open No. 2017-117384 and Japanese Patent Application Laid-Open No. 2009-104524, the line-of-sight direction of a person in a video is detected, it is difficult to accurately detect a person in a video captured by a camera in a store, in particular, a face region, because the size thereof is small. Additionally, since only the line-of-sight direction is taken into consideration, even a person who is viewing at a distance at which the person cannot gaze at the product is treated as a person who is gazing at the product.

### SUMMARY OF THE INVENTION

The present invention has been made in view of the above drawback, and one of objects of the present invention is improving the accuracy of determination regarding visual recognition of an object by a person.

A processing apparatus according to one aspect of the present invention acquires a video of a place where a target object is located; acquires characteristic information related to an angle and a distance at which the target object can be gazed at; sets a gaze region, which is a region where the target object can be gazed at, based on the characteristic information that has been acquired; and determines whether or not the person has gazed at the target object, based on information on a joint point of a person that is present in the gaze region that has been set.

Further features of the present invention will become apparent from the following description of exemplary embodiments with reference to the attached drawings.

### BRIEF DESCRIPTION OF THE DRAWINGS

FIG. 1 is a diagram illustrating an example of a hardware configuration of a processing apparatus.

FIG. 2 is a diagram illustrating a functional configuration of the processing apparatus.

FIG. 3 is a diagram of an example of a posture estimation result.

FIG. 4 is a flowchart showing the process flow in the processing apparatus.

FIG. 5 is a flowchart showing the process flow in the processing apparatus.

FIG. 6 is a diagram of an example of a product video.

FIG. 7 is a diagram of an example of product coordinate system.

FIG. 8 is a diagram of an example of the gaze region set by a gaze region setting unit.

FIG. 9 is a diagram showing an example of an in-store camera image and a gaze region.

FIG. 10 is a diagram of an example of an in-store camera video image in a case in which a shielding object is present around a product.

FIG. 11 is a diagram of an example of video captured by an in-store camera viewed on an XZ plane in a case in which a shielding object is present around the product.

FIG. 12 is an example of a gaze region in a case in which a plurality of products is present.

### DESCRIPTION OF THE EMBODIMENTS

Hereinafter, an embodiment for carrying out the present invention will be explained in detail. Note that the embodiment to be explained below are merely examples for realizing the present invention and should be appropriately modified or adjusted depending on the configuration and various conditions of an apparatus to which the present invention is applied, and the present invention is not limited to the following embodiment. Additionally, in each drawing, components having the same functions are denoted by the same reference numerals, and the description thereof will be omitted.

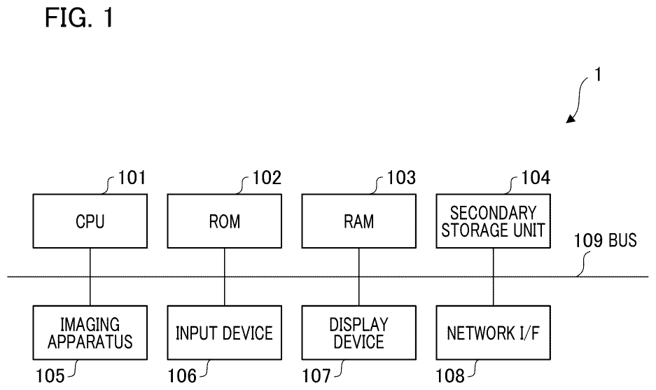

FIG. 1 is a block diagram showing a hardware configuration of a processing apparatus 1 in the present embodiment. The processing apparatus 1 according to the present embodiment determines whether or not a person has gazed at a target object, based on information on a gaze region to be described below and joint points of the person that are present in the gaze region. Additionally, the processing apparatus 1 according to the present embodiment can also detect a person who is gazing at a target object. The processing apparatus 1 in the present embodiment has a CPU 101, a ROM 102, a RAM 103, a secondary storage unit 104, an imaging apparatus 105, an input device 106, a display device 107, and a network I/F 108.

The CPU (processor) 101 is a central processing unit, and controls the entire processing apparatus 1 by executing a control program stored in the ROM 102 and the RAM 103. The ROM 102 is a non-volatile memory, and stores a control program in the present embodiment, a program and date necessary for other control. The RAM 103 is a volatile memory and stores temporary data such as frame image data and pattern determination results. The secondary storage device 104 is a rewritable secondary storage device such as a hard disk drive and a flash memory, and stores image information, a program, various setting contents, and the like. These pieces of information are transferred to the RAM 103, and the CPU 101 executes the program and uses the data. Note that the number of the CPU 101 is not limited to one and may be more than one. Furthermore, the number of the memory such as the ROM 102 is not limited to one and may be more than one.

The imaging apparatus 105 is configured by an imaging lens, an imaging sensor, for example, a CCD and a CMOS, a video signal processing unit, and the like, and captures an image and video. The input device 106 is a keyboard, a mouse, and the like, and allows input from the user. The display device 107 is configured by a cathode ray tube CRT, a liquid crystal display, and the like, and displays processing results and the like on a screen (presents them to the user). The network I/F108 is a modem, a LAN, and the like that are connected to a network such as the Internet or an intranet. A bus 109 connects these to input and output data to and from each other.

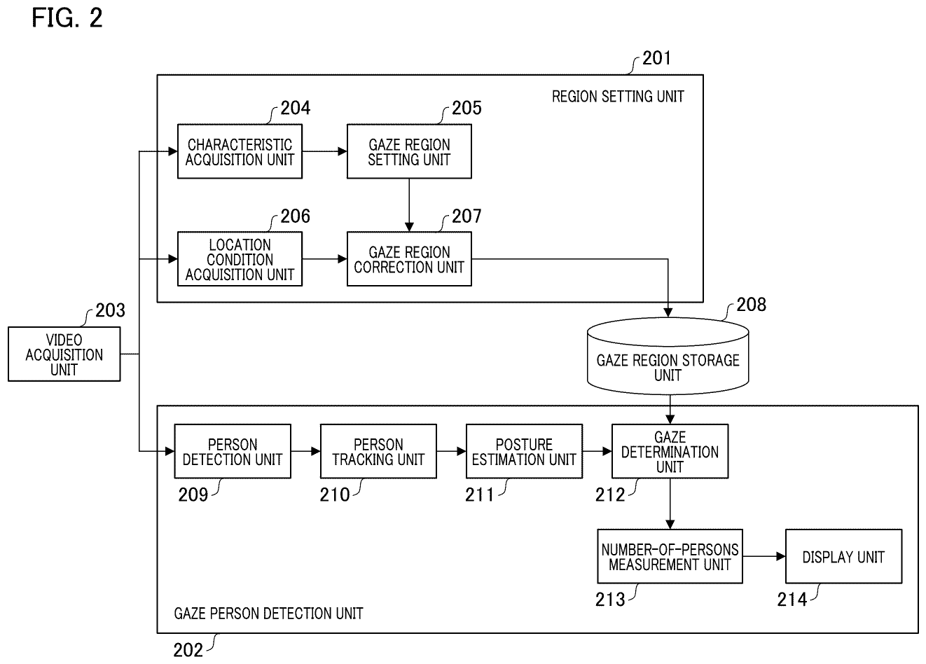

FIG. 2 is a diagram showing a functional configuration of the processing apparatus 1 in the present embodiment. The processing apparatus 1 has a region setting unit 201, a gaze person detection unit 202, a video acquisition unit 203, and a gaze region storage unit 208.

The video acquisition unit 203 is configured by the imaging apparatus 105 and obtains an image and a video. Specifically, the video acquisition unit 203 obtains a video of a specific product (target object) to be gazed at, a video of a place where the target object is located, and the like.

The region setting unit 201 is a functional unit that performs the setting of a gaze region that is a region where a product that is a target object can be gazed at. The region setting unit 201 further has a characteristic acquisition unit 204, a gaze region setting unit 205, a location condition acquisition unit 206, and a gaze region correction unit 207, which serve as its functional units.

The characteristic acquisition unit 204 acquires information on a characteristic of a product that is a target object (characteristic information). Specifically, the characteristic acquisition unit 204 acquires characteristic information that is information on an angle and a distance at which the target object can be gazed at. Details of the characteristic information of an object acquired by the characteristic acquisition unit 204 will be described below.

The gaze region setting unit 205 sets a gaze region, which is a region where the target object can be gazed at, based on the characteristic information that has been acquired by the characteristic acquisition unit 204. Note that the gaze region set by the gaze region setting unit 205 will be described below.

The location condition acquisition unit 206 acquires information on a three dimensional shape in the store (location of shelves and the like) and a three dimensional position of a product from the video. Additionally, the location condition acquisition unit 206 acquires a location condition that is a condition at a position where the product is located (product position in the video). Details of the location condition acquired by the location condition acquisition unit 206 will be described below.

The gaze region correction unit 207 corrects the gaze region set by the gaze region setting unit 205 based on the product location condition that has been acquired by the location condition acquisition unit 206. Details of the correction processing in the gaze region correction unit 207 will be described below.

The gaze region storage unit 208 is configured by the RAM 103 and the secondary storage device 104. The gaze region storage unit 208 stores information on, for example, the gaze region set by the gaze region setting unit 205 and the gaze region correction unit 207.

The gaze person detection unit 202 is a functional unit that detects and measures (counts) a person who is determined to be gazing at a product. The gaze person detection unit 202 has a person detection unit 209, a person tracking unit 210, a posture estimation unit 211, a gaze determination unit 212, a number-of-persons measurement unit 213, and a display unit 214.

The person detection unit 209 detects a region of a person from a video that has been acquired by the video acquisition unit 203. Note that it is assumed, in the present embodiment, the region of the whole body of the person is detected.

The person tracking unit 210 associates the person regions that has been acquired by the person detection unit 209 from the same person before and after the frame (frame image) in the video that has been acquired by the video acquisition unit 203, and assigns the same person ID to the person. Specifically, in the video constituted by the frame images, the same ID is assigned to the associated persons in the frame images by associating the person regions of the persons estimated to be the same in the current frame image and the frame image one before the current frame image.

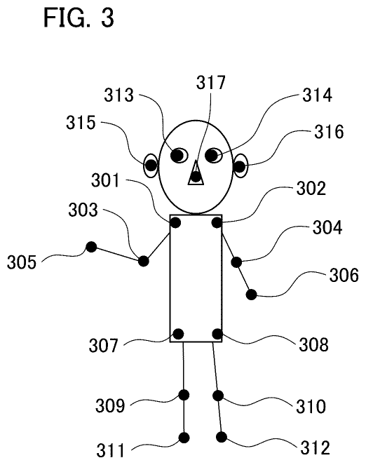

The posture estimation unit 211 acquires information on an joint point constituting the posture of the person from the region (whole body region) of the person that has been detected by the person detection unit 209. The joint point in the present embodiment represents a position of a human body part. A portion indicated as the joint point in the present embodiment will be described below with reference to FIG. 3.

The gaze determination unit 212 determines whether or not the person is gazing at the product based on the joint point that has been estimated by the posture estimation unit 211 and the gaze region that has been read out from the gaze region storage unit 208. Specifically, the gaze determination unit 212 determines whether or not the person has gazed at the target object based on the information on the joint point of the person that is present in the gaze region set by the gaze region setting unit 205.

The number-of-persons measurement unit 213 measures the time during which the person determined to be gazing at the product by the gaze determination unit 212 is gazing at the product. Additionally, the number-of-persons measurement unit 213 determines whether or not the time has reached a predetermined time. Additionally, the number-of-persons measurement unit 213 counts the number of persons determined to be gazing at the product by the gaze determination unit 212 based on the determination result.

The display unit 214 is configured by the display device 107. The display unit 214 presents the result measured by the person number measurement unit 213 to the user (displays the result on the screen of the display device 107).

Each functional unit of the processing apparatus 1 is realized by the CPU 101 deploying a program stored in the ROM 102 into the RAM 103 and executing the program. Then, the CPU 101 stores, for example, the execution results of each process to be described below in a predetermined storage medium, for example, the RAM 103 and the secondary storage device 104.

FIG. 3 is a diagram illustrating an example of a posture estimation result obtained by the posture estimation unit 211. The joint points in the present embodiment are the positions indicated by the black dots as shown in FIG. 3. That is, the joint points are a right shoulder 301, a left shoulder 302, a right elbow 303, a left elbow 304, a right wrist 305, a left wrist 306, a right hip 307, a left hip 308, a right knee 309, a left knee 310, a right ankle 311, a left ankle 312. Additionally, in the present embodiment, a right eye 313, a left eye 314, a right ear 315, a left ear 316, and a nose 317 that are the organ points of the face of the person are treated as the joint points, in addition to the parts as described above. As described above, the joint points of the present embodiment include the position information of the eyes (right eye, left eye), which are organ points of the face of a person, the position information of the ears (right ear, left ear), and the position information of the nose, in addition to the position information of the joints of the human body parts (coordinate information) as described above. Note that the joint points are not limited to the parts of the human body as described above, and other parts of the human body may also be treated as joint points.

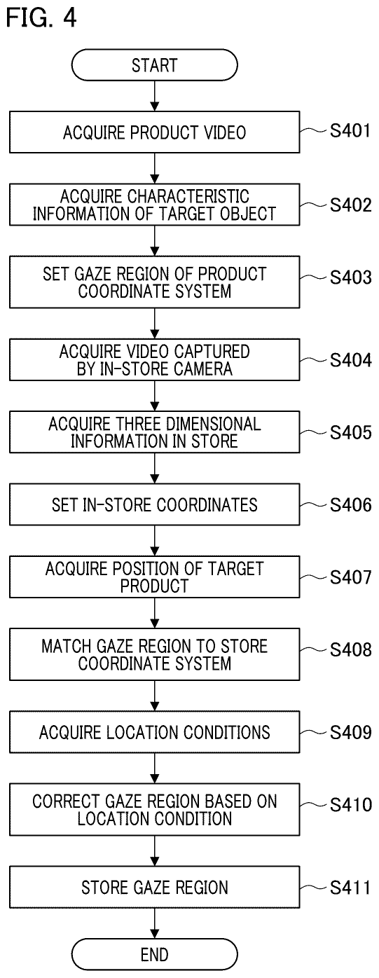

Next, the details of the process in which the processing apparatus 1 in the present embodiment sets and stores the gaze region will be explained with reference to FIG. 4. FIG. 4 is a flowchart illustrating the flow of the process of setting the gaze region in the processing apparatus 1. Note that each operation (process) as shown in the flowchart of FIG. 4 is realized by the CPU 101 of the processing apparatus 1 executing a program stored in the ROM 102. Each process (step) is denoted by adding S to the beginning of each process (step) and the notation of the processes (steps) will be omitted.

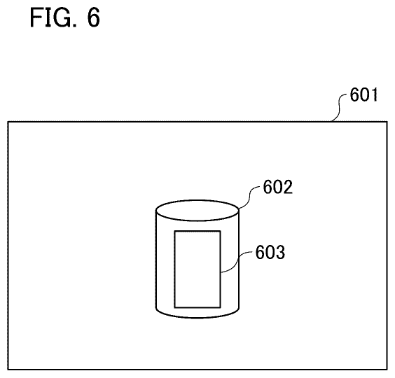

In S401, the video acquisition unit 203 acquires a video (product video) that has been captured by the imaging apparatus 105. That is, the video acquisition unit 203 acquires a video of a place where a product that is a target object is located. The video acquired by the video acquisition unit 203 is configured by a plurality of frame images. In the present embodiment, it is assumed that the video acquired by the video acquiring unit 203 in S401 is a video obtained by capturing a product in a close-up state (enlarged state) to some extent as shown in FIG. 6. FIG. 6 is a diagram showing an example of product videos. Note that FIG. 6 shows one of the frame images that configure a video.

In a frame image 601 as shown in FIG. 6, a product 602 to which a label 603 is attached is captured. Although, in FIG. 6, the product 602 is a can, which is one example, it is merely an example, and any product may be used. Note that, in S402, the video acquisition unit 203 may obtain an image and a video captured in advance by reading the image and the video from a storage unit, for example, the ROM 102 and the secondary storage device 104. Additionally, if the entire image of the product 602 can be captured, for example, in a case of capturing an image and a video of the inside of the store, the image and the video may be obtained from the image capturing apparatus. Here, in order to obtain characteristics (characteristic information) of the product 602 to be described below, it is desirable that a region of the product in the frame image has a sufficient resolution such as 200×200 pixels or more.

In S402, the characteristic obtaining unit 204 obtains the characteristic information of the product, which is the target object, from the frame image in the video obtained in S401. Here, the characteristic information is information including a character size of the label of the product or a label attached to the product (on the target object), a contrast difference between the label background and the characters, the font that is being used, the shape of the product, and the like, which are properties of the product itself that affect when a person views the product. Here, the specific methods of obtaining the characteristic information include a method of obtaining the characteristic information by analyzing an image, for example, identifying a font by utilizing a convolutional neural network (CNN). Note that a method in which a user directly inputs a character size as a numerical value via the input device 106 and the like may be used.

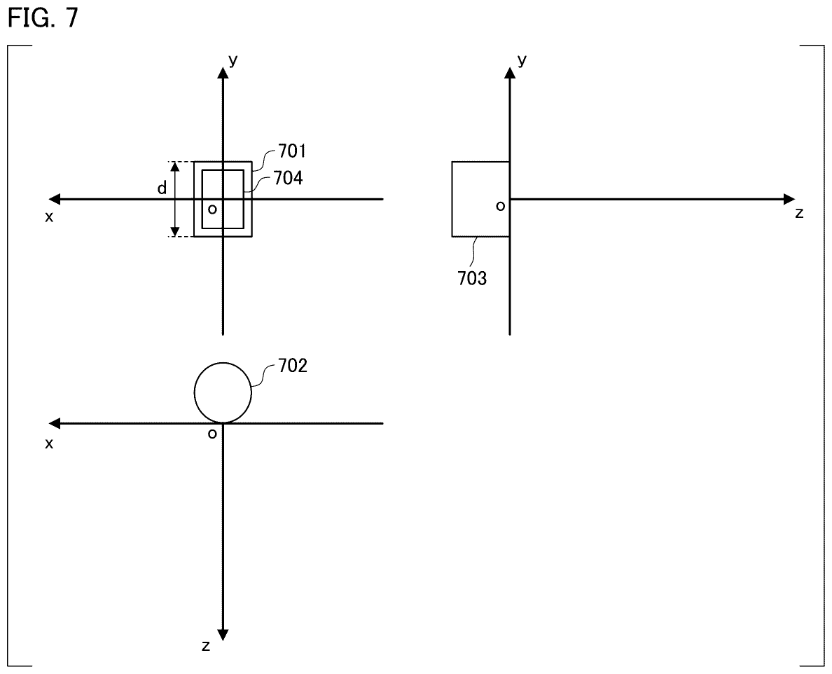

In S403, the gazing region setting unit 205 sets a gazing region of the product coordinate system. Specifically, the gaze region setting unit 205 sets a gazing region that is a region where the target object can be gazed at based on the characteristic information that has been acquired by the characteristic acquisition unit 204. The product coordinate system (x, y, z) is a three-dimensional coordinate system with the center of the surface of the product 602 as shown in FIG. 7 as an origin. FIG. 7 is a diagram that illustrates an example of the product coordinate system in the product 602 as shown in FIG. 6.

In FIG. 7, a product (product 602) is denoted by reference numeral 701 on the xy plane. Additionally, the product is denoted by reference numeral 702 on the xz plane. Additionally, the product is denoted by reference numeral 703 on the yz plane. The xy plane is in contact with the surface of the product, the z-axis is in a direction in which a perpendicular line is extended from the surface. Additionally, a label of the product (label 603) is denoted by reference numeral 704 on the xy plane. In general, it is considered that when a customer purchases a product or considers purchasing a product, the customer is trying to determine whether or not the product is necessary by gazing at the product and reading the label. Therefore, it is desirable that the origin o is set on a surface on which a label attached to a product is present. Note that, in the product coordinate system, the longest length of the product (d in the example of FIG. 7) is set to 1.

The gaze region is a partial region on a three-dimensional space that is determined by a distance from the product that is a target object to a person (a person who is present near the product) and an angle of the person with respect to the target object. Although, in the present embodiment, the gaze region is defined by a shape obtained by cutting out a part of a sphere, the gaze region may have any shape if it is a space that can be defined by a distance and an angle with respect to the target object.

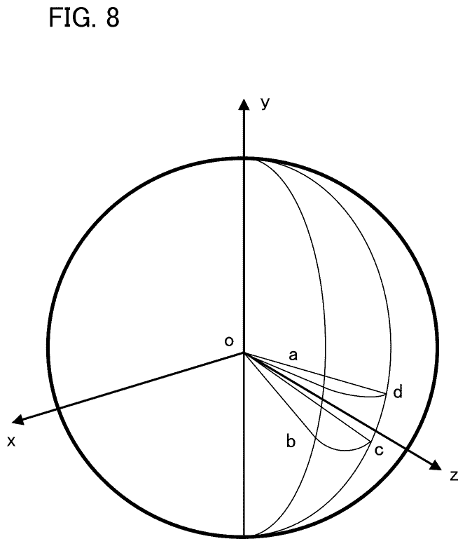

FIG. 8 is a diagram illustrating an example of a gaze region. It is assumed that the origin o is on the label surface of the product as described above. A region surrounded by o, a, b, c, and d as shown in FIG. 8 is the gaze region. In setting the gaze region, first, a sphere Q having a radius r corresponding to a distance at which gaze is possible is considered. r is oa (or ob, oc, od) in FIG. 8. As described above, the distance r at which gaze is possible depends on the size of the characters of the label, the contrast difference between the label background and the characters, the font that is used for the label, and the like among the characteristics of the target object. For example, as the character size of the label is larger, r is larger because the label can be read even from a distance. For example, if the character width is S_{c} when the short side of the label is 1 for the character size, r can be expressed by Formula (1) below.

$$r = ( {S}_{c} / {S}_{b} ) \times {D}_{b} \qquad ( 1 )$$

In the above Formula (1), D_{b} is a distance at which gaze is possible in advance under a predetermined condition (character size is S_{c}). That is, in the case of S_{c}>S_{b}, the distance r at which gaze is possible is longer. In contrast, in the case of S_{c}<S_{b}, the distance r at which gaze is possible is shorter. The contrast difference between the label and the character, the font that is used for the label, and the like are quantified and added to the reference conditions, and D_{b} is measured, whereby other characteristics can be treated in similar manner. Note that this is merely an example, and other formulas may be used if they can express the relation between the quantified object characteristics and a distance at which gaze is possible.

Next, a method of determining an angle at which it is easy to gaze at the target object, θₕ (=∠aod or ∠boc) in the horizontal direction, and θᵥ (=∠aob or ∠doc) in the vertical direction will be described. There is a method of determination based on an angle measured under a predetermined condition as in the case of the distance r. For example, θₕ in a case in which the character size is S^{e} can be expressed by Formula (2) below.

$${θ}_{h} = ( {S}_{c} / {S}_{b} ) \times {θ}_{h b} \qquad ( 2 )$$

In the above Formula (2), θ_{hb} is a horizontal angle that can be gazed at, which is measured in advance under a predetermined condition (the character size is S_{c}). The same applies to the vertical angle θᵥ. Note that θ_{hb} may be measured by quantifying and adding the contrast difference between the label and the character, the font that is used for the label, the shape of the target object, and the like to the reference conditions, and θ_{hb} may be increased or decreased based on a ratio between the value of each condition and the reference condition. Note that this is merely an example, and another mathematical formula may be used if it can represent the relation between the quantified characteristics of the object and the angle at which the object can be gazed.

In the gaze region setting unit 205, the gazing region is set in a direction perpendicular to the object surface, for example, in the z-axis direction in FIG. 8. That is, the z-axis passes through the center of abcd and matches the center line of the gaze region (a line segment from o to the center point of abcd). Note that, in the gaze region correction unit 207, the direction and scale of the center line is changed according to the position where the product is located, as will be described below.

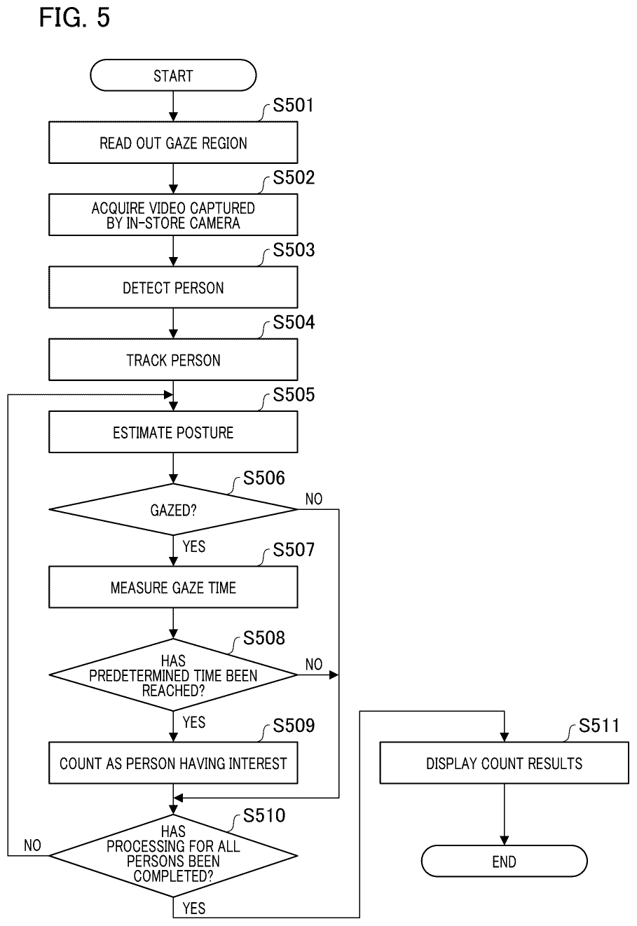

In S404, the video acquisition unit 203 acquires a video (in-store video) of a place where a product (target object) is located in the store and the like, which has been captured by the imaging apparatus 105. The video acquired by the video acquisition unit 203 is configured by a plurality of frame images. Note that, in S404, the video acquisition unit 203 acquires a video having the same angle of view as that in S502 in FIG. 5, which will be described below.

In S405, the location condition acquisition unit 206 acquires information on a three dimensional shape (for example, location of shelves) in the store from the in-store video that has been acquired in S404. The specific methods of acquiring the location information include a method of estimating depth information in each pixel from an image using Vision Transformer (ViT). Additionally, a method may be used in which a combined video generated in advance by a three-dimensional CG model is displayed to be overlaid on the in-store video, and a user adjusts the size and the like of the CG model while checking the combined video to perform fitting.

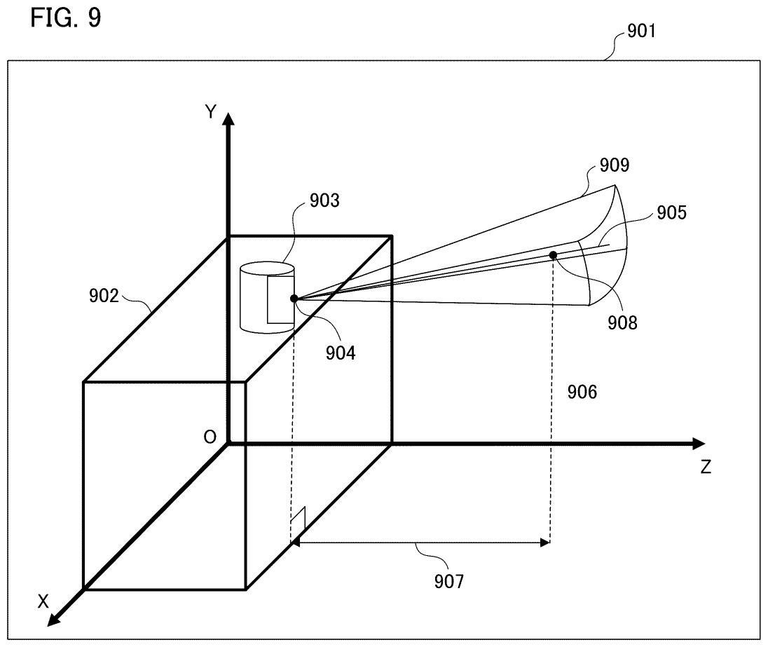

FIG. 9 is a diagram showing an example of an in-store camera video and a gaze region. A shelf 902 and a product 903 are captured in a frame image 901 that is a part of the video shown in FIG. 9. Specifically, the product 903 is located on the shelf 902. In S405, the location condition acquisition unit 206 acquires the three-dimensional shapes of these produces.

In S406, a coordinate system indicating each coordinate of the three-dimensional shape is set. A world coordinate system (hereinafter, referred to as an “in-store coordinate system”) with a specific position (in FIG. 9, a point O at the left rear of the shelf) of the in-store video as an origin is used. In the present embodiment, the XZ plane is the floor, the X-axis is the horizontal direction of the shelf, the Z-axis is the depth direction of the shelf, and the Y-axis is the height direction of the shelf. In each of these axes, the length in the real world (in the present embodiment, the length of the long side of the product) is used as a unit. Note that the position of the origin, the X-axis, the Y-axis, the Z-axis, the lengths of the long sides of the products, and the like are set by being input by the user (operator) via the input device 106 while checking the video in the store.

In S407, the location condition acquisition unit 206 acquires the three-dimensional position of the product (product 903). The location condition acquisition unit 206 acquires the three-dimensional position of the product based on a user instruction via the input device 106.

In S408, the gaze region correction unit 207 adapts the gaze region that has been set by the gaze region setting unit 205 to the position where the product is located. That is, it adapts the gaze region to the in-store coordinate system. At the time of this processing, first, scaling of the gaze region expressed by the product coordinate system is performed based on the lengths of the long sides of the product in the real world to match the in-store coordinate system. Next, the vertex o of the gaze region is shifted to a center position 904 of the label of the product. Next, the direction of a center line 905 of the gaze region in the xz plane is aligned with the normal to the surface of the product. Next, the direction of the yz plane is determined based on the height information of the person. Specifically, it is determined based on the average height of the person who is assumed to gaze at the target object.

Here, it is assumed that the average height is matched to the customer segment targeted by the product. For example, the average height is set to 170 cm for adult males, and 120 cm for elementary students. Note that, as for the average height, the user may be allowed to select an already set height according to the target customer segment, or the user may arbitrarily set the average height.

Taking FIG. 9 as an example, it is assumed that a person having an average height 906 is made to stand at a position at a predetermined ratio of the distance (the distance r that is the radius of the sphere as shown in FIG. 8) at which the person can gaze from the product position. The reason why the distance r at which gaze is possible is not used as it is that the distance r is the distance of a limit at which gaze is possible and it is assumed that a customer often stands at a position at an optimum distance at which the customer can view the product most easily. In FIG. 9, the center of the head when a person having an average height stands at the position of an optimal gaze distance 907 is set as 908. The direction in the xz plane is adjusted so that the center line 905 of the gaze region passes through the head center 908. As described above, the gaze region correction unit 207 adjusts the gaze region to the location position of the product in the store. A gaze region 909 indicates a gaze region in a case in which the gaze region is adapted to the location position of the product in the store.

In S409, the gaze region correction unit 207 acquires location information that is information on a condition related to location other than the three-dimensional position of the product. Here, the information on the location condition (location information) other than the three-dimensional position is information on an illumination condition (brightness, color temperature of light source, light source direction, and the like), a position of a shielding object around the product, and the like. Methods of acquiring the illumination condition include a method of acquiring an illumination condition from an image by using a gray world assumption and a method in which a user specifies the type of light source. Although the information on the position of the shielding object around the product may be acquired by, for example, a method using ViT, the method for acquiring the information on the position of the shielding object around the product is not limited thereto and may be acquired by using any method.

In S410, the gaze region correction unit 207 corrects the gaze region based on the location condition (location information) of the product. In correcting the gaze region in S410, for example, if the brightness is lower than a predetermined value, the distance at which gaze is possible may be reduced. The predetermined value is obtained by an experiment in advance, and when the brightness is lower than the predetermined value, the length of the center line of the gaze region is changed by Formula (3) below according to a difference value ΔV in the brightness.

$$L = 1 / Δ V \times α \times {L}_{1} \qquad ( 3 )$$

In the above Formula (3), L₁ is the length of the center line of the gaze region before correction, and α is a coefficient for adjusting the range of values. Note that this is merely an example, and another formula may be used if the ratio of correction can be expressed based on the relation between the quantified location condition and the distance at which gaze is possible.

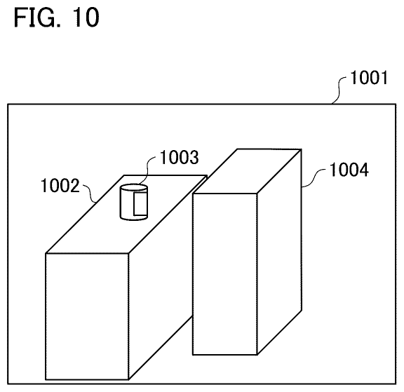

FIG. 10 is a diagram of an example of a video captured by an in-store camera in a case in which a shielding object is present around a product. As shown in FIG. 10, when a shielding object is present around the product, a region that can be gazed at is limited. Taking FIG. 10 as an example, a case in which a shelf 1002 and a product 1003 are present in an in-store camera video 1001 and a column 1004 protrudes is assumed. In such a case, since a person cannot stand on the right side in front of the shelf 1002, the person cannot gaze at the product 1003 from the right side. Hence, it is specified that a shielding object (for example, the column 1004) is present around the product, based on the positional relation between the three-dimensional information in the store that has been acquired in S405 and the gaze region that has been adapted in S408 (position information of the shielding object is acquired).

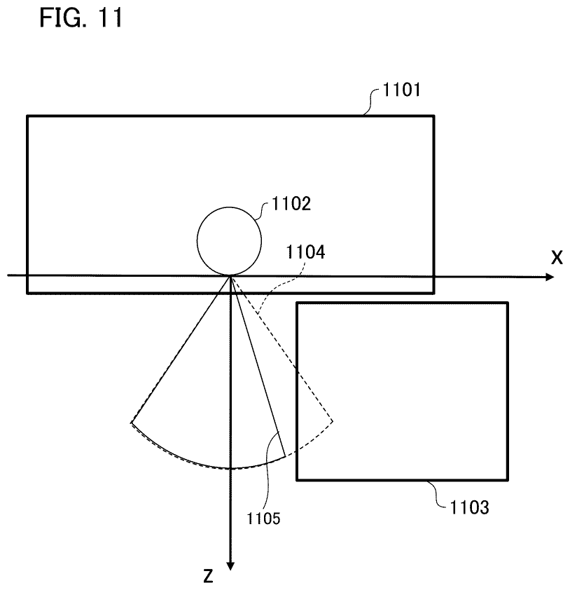

FIG. 11 is a diagram of the inside of the store in FIG. 10 viewed on the xz plane (from the ceiling). In FIG. 11, reference numeral 1101 denotes a shelf, reference numeral 1102 denotes a product, and reference numeral 1103 denotes a column. In the correction of the gaze region based on the shielding object, only the angle on the right side in the drawing is corrected as in a gaze region 1105 indicated by the solid line so that a gaze region 1104 shown by the dotted line does not overlap with the column 1103. Thus, the gaze region correction unit 207 corrects the gaze region so as not to overlap with the shielding object, based on the position information of the shielding object in which the region where the person can gaze at is limited from the location information.

In S411, the gaze region correction unit 207 stores the gaze region that has been corrected in S410 (corrected gaze region) in the gaze region storage unit 208. Subsequently, the processes in the flow of this process, that is, the process in which the processing apparatus 1 sets and stores the gaze region ends.

Next, a process in which the processing apparatus 1 in the present embodiment detects and measures (counts) a person who is determined to be gazing at a product will be explained in detail with reference to FIG. 5. FIG. 5 is a flowchart illustrating a flow of the process of detecting and measuring a person who is determined to be gazing at a product in the processing apparatus 1. Note that each operation (process) illustrated in the flowchart in FIG. 5 is realized by the CPU 101 of the processing apparatus 1 executing a program stored in the ROM 102. Each process (step) is denoted by adding S to the beginning of each process (step) and the notation of the processes (steps) will be omitted.

In S501, the gaze determination unit 212 reads out the gaze region from the gaze region storage unit 208 and temporarily stores the gaze region in the RAM 103. Note that the gaze region read out from the gaze region storage unit 208 by the gaze determination unit 212 in S501 is the gaze region (corrected gaze region) stored in S411 as described above.

In S502, the video acquisition unit 203 acquires a video of the inside of the store from the imaging apparatus 105 in a unit of a frame image while associating the video with time information. The time information is at least one of a time stamp and a frame ID. Note that the video acquisition unit 203 acquires a video having the same angle of view as the video that has been acquired in S404.

In S503, the person detection unit 209 detects a person (a region of a person) from a frame image in the video that has been acquired in S502. That is, the person detection unit 209 detects a region of a person in a frame for each of a plurality of frames. Here, specific methods of person detection include a method using CNN.

Note that the person detection method may be any method if the person region can be detected and is not limited to the method using CNN. Although, in the present embodiment, the whole body region is used as a target of person detection, a region of a part of a person, for example, an upper body region may also be used.

The whole body region is represented by the x coordinate and the y coordinate of two points at the upper left and the lower right of a rectangle surrounding the person with the upper left of the frame image as the origin. Additionally, time information of the frame image is assigned to each whole body region.

In S504, the person tracking unit 210 performs processing of tracking which person's whole body region detected in the previous frame (the frame image one before the latest frame image) corresponds to the whole body region detected in the current frame (the latest frame image). Additionally, the person tracking unit 210 further assigns a person ID issued for each person to each whole body region.

Here, there are various methods in which the person tracking unit 210 performs the tracking processing, for example, there is a method in which the center position of the whole body region included in the previous frame and the center position of the whole body region of the person included in the current frame are associated with each other, which is the shortest. In addition to this, any other method including a method by pattern matching using the whole body region of the previous frame as a collation pattern may be used if the whole body regions of the person between the frames can be associated with each other.

In S505, the posture estimation unit 211 estimates the posture of the person from all the whole body regions in the frame image, and outputs the joint points corresponding to each of the whole body regions in the form of a list. Here, as a specific method of posture estimation, for example, there is a method of estimating three dimensional coordinates of each joint point using CNN and obtaining the degree of reliability thereof. Additionally, a method of obtaining the joint point on the two-dimensional coordinates first and then estimating the position of the joint point on the three-dimensional coordinates may be used as another method. Specifically, the posture estimation unit 211 estimates the postures of all the persons in a plurality of frame images, estimates or calculates the coordinates (positions) of each of the joint points from the posture estimation result, and outputs the information on the joint points in the form of a list. Note that the method is not limited to the above-described method if the three-dimensional coordinates of the joint point can be estimated.

A plurality of joint point lists is created for each whole body region (person) included in the frame image. Each of the joint point list is obtained by arranging the time information of the frame image, the person ID, and the coordinates and degree of reliability of all the joint points of the person in a specific order.

In S506, the gaze determination unit 212 determines whether or not a person who is present in the gaze region is gazing at a product (target object) based on the joint point list that has been output by the posture estimation unit 211 in S505 and the gaze region that has been read out in S501. When it is determined that the person is gazing at the product (“YES” in S506), the process proceeds to S507. In contrast, when it is determined that the person is not gazing at the product (“NO” in S506), the process proceeds to S509.

The gaze determination in S506 is performed on the assumption that when a face is present in the gaze region, there is a high possibility that the person is gazing at. The accuracy of the coordinates of the facial organ points on the side not viewed from the camera tends to decrease, and the direction of the line of sight obtained from the positions of the facial organ points as in the prior art tends to have a large error, and the gaze determination accuracy tends to deteriorate. In contrast, since the gaze region is fixed and stable at the position of the product, the gaze determination can be performed more accurately.

Specifically, for example, the average coordinates of five points of the right eye 313, the left eye 314, the right ear 315, the left ear 316, and the nose 317, which are facial organ points, are set as the center position of the face. Then, the gaze determination unit 212 determines whether or not the person is gazing at a product by determining whether or not the center position is within the gaze region (first determination) and determining whether or not the face is facing the product based on the positional relation between the left and right eyes and ears (second determination). That is, the gaze determination unit 212 performs the first determination in which whether or not the average coordinates of the coordinates of the right eye, the left eye, the right ear, the left ear, and the nose of the person who is a determination target are within the gaze region is determined. Furthermore, the gaze determination unit 212 performs the second determination in which whether or not the face of the person faces the target object is determined based on the positional relation between the right eye, the left eye, the right ear, and the left ear of the person who is a determination target, whereby whether or not the person has gazed at the target object is determined.

Additionally, in a case in which a facial organ point cannot be detected due to the influence of hiding and the like, the center position estimated from other joint points such as the right shoulder 301, the left shoulder 302, the right waist 307, and the left waist 308 may be used. For example, a position extending upward from the center coordinates of both shoulders by a predetermined ratio of the length from the shoulders to the waist is set as the center position of the face.

Note that if a plurality of products is present, a gaze region corresponding to each product is set and the gaze determination is performed for each gaze region. Specifically, the gaze region setting unit 205 sets, for each target object, a gaze region in which the target object can be gazed at based on the characteristic information that has been acquired by the characteristic acquisition unit 204. Furthermore, in a case in which a plurality of gaze regions is set, the gaze determination unit 212 determines whether or not a person who is present in the gaze region is gazing at a product (target object), for each of the set gaze regions.

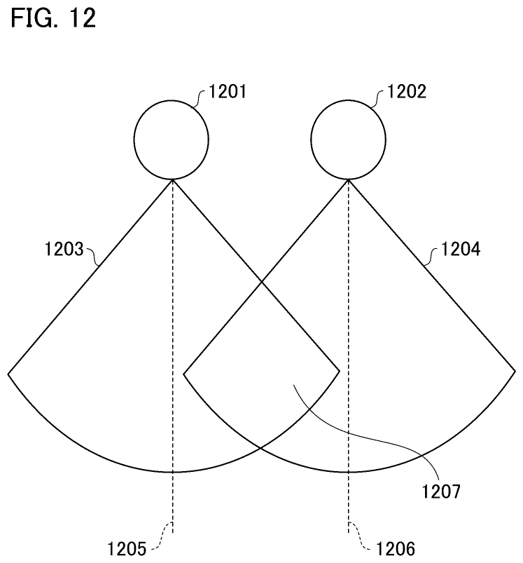

FIG. 12 is a diagram of a plurality of gaze regions set for a plurality of products as viewed on the xz plane. In FIG. 12, a product 1201 and a product 1202 are located side by side. A gaze region 1203 is a gaze region set for the product 1201. A gaze region 1204 is a gaze region set for the product 1202. A center line 1205 shown by a dotted line is a center line of the gaze region 1203. A center line 1206 is a center line of the gaze region 1204. The gaze region 1203 and the gaze region 1204 overlap each other in a region (overlapping region) 1207.

Here, when the center position of the face of the person as described above is within the overlap region 1207, the gaze determination unit 2112 determines that the person is gazing at a product closer to the center line 1205 or the center line 1206. Specifically, in a case in which the center position of the person is within a region where one gaze region and another gaze region partially overlap each other, the gaze determination unit 212 determines which product (target object) the person has gazed at, based on the center line of each gaze region (center position information).

Note that since a case in which two products are compared can also be assumed, the gaze determination unit 212 may determine that the person is gazing at both the product 1201 and the product 1202 at the same time. Additionally, the gaze determination unit 212 may also determine that the person is comparing two products while determining that the person is gazing at a product closer to the center line. Although the case of two gaze regions for two products has been described above as an example, the same applies to a case in which a plurality of gaze regions for three or more products are set.

In S507, the number-of-persons measurement unit 213 measures (calculates) a time (gaze time) from a time point at which the gaze is determined for the first time from the time information of the person. Subsequently, it temporarily stores the time information in the RAM 103.

In S508, the number-of-persons measurement unit 213 reads out the gaze time temporarily stored in S507, and determines whether or not the gaze time has reached a predetermined time. Specifically, when the gaze determination unit 212 determines that the person in the gaze region is gazing at the target object, the number-of-persons measurement unit 213 determines whether or not the gaze time has reached a predetermined time based on the information on the time during which the person is gazing at the target object. When it is determined that the gaze time has reached the predetermined time (“YES” in S508), it is determined that the person is interested in the target object, and the process proceeds to S509. In contrast, if it is determined that the gaze time has not reached the predetermined time (“NO” in S508), it is determined that the person does not show an interest in the target object, and the process proceeds to S510. Note that the predetermined time is set to an arbitrary time in advance.

In S509, the number-of-persons measurement unit 213 counts (measures) a person who is determined to be gazing at the target object by the gaze determination unit 212 as a person who is interested in (shows interest in) the product.

In S510, it is determined whether or not all the processes have been completed for all the persons (whole body regions) included in the current frame image. When it is determined that all the processes have not been completed for all the persons (whole body regions) (“NO” in S510), the process returns to S505, and the same processes are performed. In contrast, when it is determined that all the processes have been completed for all the persons (whole body regions) (“YES” in S510), the process proceeds to S511.

In S511, the display unit 214 presents the counting result of S509 to the user via the display device 107 (displays the counting result on the screen of the display device 107). Subsequently, the processing flow ends. In this processing, for example, a message (notification), for example, “There are five persons interested in the product” is displayed on the screen of the display device.

Although, in the explanation of the present embodiment, the processing result is notified to the user, the processing of creating statistical information and the like may further be performed. Alternatively, a mobile device, for example, a tablet and a smartphone may be carried by a store clerk and a staff member who work in the store, and, in S508, a message of, for example, “There is a person who is interested in the product” may be notified to the store clerk carrying the mobile device at a time point when the gaze time reaches a predetermined time. By providing such a notification, it is possible to prompt the salesclerk to explain the product to the target person (the person who is gazing at the product).

The flow of the processing of the processing apparatus 1 in the present embodiment has been described above. Although, in the above description, the flow of the processes until a person who is interested in the product is counted has been sequentially described, it is assumed that all the steps after S502 are always repeated until the processing of the processing apparatus 1 ends.

As described above, according to the processing apparatus 1 in the present embodiment, it is possible to set a gaze region defined by an angle and a distance at which the person can gaze at the product (target object). Since the gaze region set by the processing apparatus 1 in the present embodiment is a region fixed at the position of the product, it is possible to accurately perform the gaze determination (to improve the determination accuracy of the gaze behavior of the person).

In the present embodiment, a configuration in which all the functions are incorporated in one apparatus is used. However, the present invention is not limited thereto, for example, the processes of transmitting the video acquired from the video acquisition unit 203 to the cloud, performing the processing of the gaze region setting unit 205 on the cloud to set the gaze region, and storing the gaze region in the storage unit on the cloud are performed. Subsequently, a configuration in which a series of processes of transmitting the information on the gaze region set on the cloud to a processing apparatus configured by a PC and the like, performing the gaze determination processing as described above, and counting a person who is determined to be gazing at the product and presenting the person to the user may be performed.

Additionally, the processing apparatus 1 in the present embodiment may be linked to or combined with the measurement of the time for which a person stops in front of the product and the analysis of the action of reaching for a product, to form a part of a system for analyzing the customer's interest level in the product.

The object of the present invention may also be achieved by the following method. A recording medium (or storage medium) storing a software program code for achieving the functions of the embodiment as described above is supplied to a system or apparatus. Then, a computer (or a CPU, a MPU, and a GPU) of the system or apparatus reads out and executes the program code stored in the recording medium. In this case, the program code itself that has been read out from the recording medium realize the functions of the embodiment as described above, and the recording medium in which the program code is recorded configures the present invention. Additionally, the function can also be realized by a circuit (for example, an ASIC) that realizes one or more functions.

Additionally, the functions of the embodiment as described above are realized only by executing the program code that has been read out by the computer. An operating system (OS) and the like running on the computer may perform part or all the actual processing based on an instruction of the program code.

Furthermore, a case in which the functions of the embodiment as described above are realized by the following method is also included. The program code that has been read out from the recording media are written in a memory provided in a functional extension card inserted into the computer or a functional extension unit connected to the computer. Subsequently, for example, a CPU provided in the functional extension card or the functional extension unit performs part or all of actual processing, based on the instruction of the program code.

In a case in which the present invention is applied to the recording medium as described above, the program code corresponding to the flowcharts as explained above is stored in the recording medium.

Although the preferred embodiments of the present invention have been explained as described above, the present invention is not limited to these embodiments, and various modifications and changes can be made within the scope of the gist of the present invention. For example, some of the functional blocks as shown in FIG. 2 may be included in an apparatus that is different from the processing apparatus 1. More specifically, a storage device that is different from the processing apparatus 1 may have the function of the gaze region storage unit 208, and the processing apparatus 1 and the storage device may perform communication based on wired or wireless connection to realize the functions of the embodiment. Similarly, one or more functional blocks in FIG. 2 including the region setting unit 201, the gaze person detection unit 202, and the video acquisition unit 203 may be realized by one or more computers that is different from the processing apparatus 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-101648. Jun. 21, 2023, which is hereby incorporated by reference wherein in its entirety.

What is claimed is:

1. A processing apparatus comprising:
one or more memories storing instructions; and
one or more processors executing the instructions to:
acquire a video of a place where a target object is located;
acquire characteristic information related to an angle and a distance at which the target object can be gazed at;
set a gaze region, which is a region where the target object can be gazed at, based on the characteristic information that has been acquired; and
determine whether or not the person has gazed at the target object, based on information on a joint point of a person that is present in the gaze region that has been set.

2. The processing apparatus according to claim 1, wherein the one or more processors performs correction of matching the gaze region to a position where the target object is located in the video based on height information of the person.

3. The processing apparatus according to claim 1, wherein the gaze region is a partial region in a three-dimensional space determined by a distance from the target object to the person and an angle of the person with respect to the target object.

4. The processing apparatus according to claim 1, wherein the one or more processors acquire location information related to a location of the target object.

5. The processing apparatus according to claim 4, wherein the one or more processors correct the gaze region based on the location information.

6. The processing apparatus according to claim 4, wherein the location information is information including at least one of information on a position where the target object is located, an illumination condition, and a position of a shielding object around the target object.

7. The processing apparatus according to claim 6, wherein the gaze region is corrected so as not to overlap with the position of the shielding object based on the position of the shielding object.

8. The processing apparatus according to claim 1, wherein the one or more processors acquire the video in a plurality of frames, detects a region of a person in each of the plurality of frames, estimates a posture from the detected region of the person, and estimates information on a joint point of the person based on the posture.

9. The processing apparatus according to claim 1, wherein the information on the joint point includes coordinate information of a right eye, a left eye, a right ear, a left ear, and a nose of the person, in addition to coordinate information of each joint of the person.

10. The processing apparatus according to claim 9, wherein the one or more processors determine whether or not the person has gazed at the target object by performing a first determination in which whether or not a center position is within the gaze region is determined, the center position being an average coordinate of coordinates of a right eye, a left eye, a right ear, a left ear, and a nose of the person, and a second determination in which whether or not the person faces the target object is determined based on a positional relation between a right eye, a left eye, a right ear, and a left ear of the person.

11. The processing apparatus according to claim 10, wherein, in a case in which a plurality of the target objects and the gaze regions is present and the center position of the person is present within a region where one gaze region and another gaze region partially overlap, the one or more processors determine which target object the person has gazed at, based on center position information of each of the gaze regions.

12. The processing apparatus according to claim 1, wherein, in a case in which the one or more processors determines that the person within the gaze region has gazed at the target object, it determines whether or not the person is interested in the target object, based on information on a time during which the person is gazing at the target object.

13. The processing apparatus according to claim 12, wherein the one or more processors counts the number of persons who are determined to be interested in the target object and display the number of counted persons on a display device.

14. The processing apparatus according to claim 1, wherein the characteristic information is information including any one of a size of a character on the target object, a contrast difference between a background and a character, a font used, and a shape of the target object.

15. A control method of a processing apparatus, comprising:
acquiring a video of a place where a target object is located;
acquiring characteristic information related to an angle and a distance at which the target object can be gazed at;
setting a gaze region, which is a region where the target object can be gazed at, based on the characteristic information that has been acquired; and
determining whether or not the person has gazed at the target object, based on information on a joint point of a person who is present in the gaze region that has been set.

16. A non-transitory computer-readable storage medium configured to store a computer program comprising instructions for executing following processes:
acquiring a video of a place where a target object is located;
acquiring characteristic information related to an angle and a distance at which the target object can be gazed at;
setting a gaze region, which is a region where the target object can be gazed at, based on the characteristic information that has been acquired; and
determining whether or not the person has gazed at the target object, based on information on a joint point of a person who is present in the gaze region that has been set.
